(19) United States
(12) Patent Application Publication
(10) Pub. No.: US 2004/0118534 A1
(43) Pub. Date: Jun. 24, 2004

(54) Low formaldehyde creping composition and product and process incorporating same

(76) Inventor: Ralph Lee Anderson, Marietta, GA (US)

Correspondence Address: PAULEY PETERSEN KINNE & ERICKSON, 2800 WEST HIGGINS ROAD, SUITE 365, HOFFMAN ESTATES, IL, 60195, US

(21) Appl. No.: 10/326,354

(22) Filed: Dec. 19, 2002

(51) Int. Cl. B31F 1/12

(52) U.S. Cl. 162/111; 264/282; 162/184

(57) ABSTRACT

A creping composition including a crosslinkable polymer that releases formaldehyde during crosslinking, a filler material and a water-soluble glycol compound is disclosed. Also disclosed is a creped material including the creping composition and a process for making the same.

### FIELD OF INVENTION

The present invention relates to a creping composition that produces a lower amount of formaldehyde residue in a creped material. A creped material and process for making the same are also disclosed.

### BACKGROUND OF THE INVENTION

Liquid absorbent products such as paper towels, tissue paper, feminine hygiene products, industrial wipers, food service wipers, napkins, medical pads, and other similar products are designed to include several important properties. For example, the products should generally have good bulk, a soft feel and should be highly absorbent. The products should also have strength even when wet and should resist tearing. Furthermore, many products should also have good stretch characteristics, should be abrasion resistant, and should not deteriorate in the environment in which they are used.

One process that has proven to be very successful in producing soft, absorbent, single ply fibrous webs having a laminate like structure that are particularly well suited for use as wiping products is disclosed in U.S. Pat. No. 3,879,257 to Gentile, et al., which is incorporated by reference in its entirety.

The fibrous webs disclosed in Gentile et al. are formed from an aqueous slurry of principally lignocellulosic fibers under conditions that reduce interfiber bonding. A bonding material or creping composition such as, for example, a latex elastomeric composition, is applied to a first surface of the web in a spaced-apart pattern. The bonding material provides strength to the web as well as abrasion resistance to the surface of the web.

Once the bonding material is applied to the first side of the web, the web can be brought into contact with a creping surface. Specifically, the web will adhere to the creping surface according to the application pattern of the bonding material. The web is then creped from the creping surface with a doctor blade. Creping the web greatly disrupts the fibers within the web thereby increasing the softness, absorbency, and bulk of the web.

In one embodiment disclosed in Gentile et al., both sides of the web are creped after the bonding material has been applied. Thus, the bonding material can be applied in a manner similar to that of the first side to the opposite side of the web to provide additional strength and abrasion resistance.

Bonding materials used in creping fibrous webs typically include a crosslinkable polymer that contains functional groups, such as n-methylol acrylamide, that are crosslinked in the presence of an acid catalyst during the creping process. However, the crosslinking reaction often generates formaldehyde, such as by a condensation reaction, which is absorbed by the fibers of the web and remains resident in the resulting creped product.

Increasingly, regulations and health concerns have mandated lower and lower formaldehyde levels in products. Formaldehyde absorb by the fibers (“free formaldehyde”) can be released to the surrounding environment at a pH of 7 or greater such as when the fibers are wetted. Additionally, the released formaldehyde can react with other compounds in or on the fibers to form undesirable and/or noxious odors. For example, when formaldehyde reacts with ammonia a methylamine compound having a distinctly fish-like odor can be produced.

Some manufacturers of creping materials have attempted to reduce the level of formaldehyde generated during crosslinking by adjusting the degree of crosslinking and by utilizing various acid catalysts. Others have attempted to control formaldehyde emissions from creped materials by including high surface area pigments, such as diatomaceous earth, or malodor absorbers, such as certain organic acids. However, many of these treatments are sprayed or coated onto the surface of the creped product as a post-forming treatment thereby adding an additional production step.

With the foregoing in mind, there is a need or desire for a bonding material or creping composition that produces a lower amount of free formaldehyde residue in a creped material. There is also a need or desire for a creped material that includes a lower level of free formaldehyde and may be produced efficiently and economically.

Therefore, it is a feature and an advantage of the present invention to provide a creping composition that produces a reduced level of free formaldehyde residue in a creped material. It is a further feature and advantage to provide a creped material including the creping composition of the present invention having a lower level of free formaldehyde residue than a comparable creped material.

### SUMMARY OF THE INVENTION

The present invention is directed to a creping composition including a crosslinkable polymer that releases formaldehyde during crosslinking, a filler material and a water-soluble glycol compound. The creping composition may have a glass transition temperature of about −30 degrees Celsius to about 10 degrees Celsius. The crosslinkable polymer may be present in an amount of about 70 to about 90 weight percent based on the total weight of solids in the creping composition. Suitably, the crosslinkable polymer includes a crosslinkable ethylene vinyl acetate (EVA) copolymer that may include n-methylol acrylamide functional groups. The filler material may be present in an amount of about 5 to about 30 weight percent based on total weight of solids in the creping composition. Suitably, the filler material may include clay, titanium dioxide, talc, calcium carbonate or a combination thereof. Desirably, the filler material has a mean particle size of less than about 2 microns. The water-soluble glycol compound may be present in amount of about 0.5 to about 5.0 weight percent based on total weight of solids in the creping composition. Suitably, the water-soluble glycol compound may include glycerin, polyethylene glycol compounds, polypropylene glycol compounds, or combinations thereof. Desirably, the polyethylene glycol compounds have a weight average molecular weight of about 200 to about 1000. The creping composition may also include a latent acid catalyst present in an amount of about 0.3 to about 2 weight percent based on the total weight of crosslinkable polymer. Suitable latent acid catalysts include ammonium chloride, citric acid, maleic acid and combinations thereof.

A creped material of the present invention may include a fibrous base web and a creping composition including a crosslinked polymer and a filler material. The filler material includes an ester formed from formaldehyde and a water-soluble glycol compound. The creped material may include at least about 25 percent less free formaldehyde than a comparable creped material including the same crosslinked polymer and at least about 10 percent less free formaldehyde than a comparable creped material including the same crosslinked polymer and filler material.

A process for producing a creped material includes: providing a fibrous base web; applying a creping composition as disclosed above to at least a first side of the fibrous base web; adhering the at least first side of the fibrous base web to a first creping surface; and creping the fibrous base web from the first creping surface. Suitably, the creping composition is applied in an amount of about 2 to about 15 weight percent based on total weight of the base web and in a pattern that covers about 20 to about 50 percent of the first side of the fibrous base web. The process may also include: applying the creping composition as disclosed above to a second side of the fibrous base web; adhering the second side of the fibrous base web to a second creping surface; and creping the fibrous base web from the second creping surface.

### DEFINITIONS

The term “latex” refers to the final product of an emulsion polymerization in which very small particles of polymer are suspended in an aqueous medium; such polymerization involves a colloidal suspension. A latex typically is prepared by the radical chain polymerization of one or more unsaturated monomers that are in the form of emulsions. The phrases “functional group-containing polymer in the form of a latex” and “functional group-containing latex” are synonymous and refer to the polymer per se which is dispersed in an aqueous medium. Unless stated otherwise, references to amounts of the polymer or the latex are on a dry basis.

The term “functional group” is used herein to mean the part of a molecule wherein its chemical reactions occur. A molecule may have a single functional group, two or more functional groups of the same type or class, or two or more functional groups of two or more different types or classes.

The terms “crosslinkable polymer” and “crosslinkable ethylene vinyl acetate (EVA) copolymer” as used herein, refer to a compound that includes functional groups in the polymer backbone. The functional groups in the polymer backbone react with a catalyst to crosslink the polymer. The functional groups in the crosslinkable polymer in general may be any functional group containing one or more active hydrogen atoms. Examples of such groups include carboxy, amino, hydroxy, mercapto, sulfo, sulfino, and sulfamino groups, although such groups are not necessarily equally effective or desirable. The more commonly available, and also more desirable, functional groups are carboxy and amino. One specific functional group is n-methylol acrylamide.

As used herein, the term “clay” refers to a fine-grained deposit consisting chiefly of clay minerals. Very small particles, chiefly hydrous silicates of aluminum, sometimes with magnesium and/or iron substitution for all or part of the aluminum, are the major constituents of clay materials. The particles are essentially crystalline (either platy or fibrous) with a layered structure, but may be amorphous or metalloidal. The clay minerals are responsible for the plastic properties of clay; the particles have the property of being able to hold water. The chief groups of clay minerals are: kaolinite (Al₄Si₄O₁₀(OH)₈) the chief constituent of kaolin; halloysite (Al₄Si₄O₁₀(OH)₈. 4H₂O); illite (KAl₄(SiAl)₈O₁₈.2H₂O); montmorillonite ((Na,Ca)_{0.33}(Al,Mg)₂Si₄O₁₀(OH)₂.nH₂O) formed through the alteration of volcanic ash; and vermiculite ((Mg,Fe,AI)3(Al,Si)₄O₁₀(OH)₂.4H₂O), used as an insulating material and a potting soil.

The term “kaolin clay” used herein refers to a soft white clay that is composed chiefly of the mineral kaolinite. It is formed during the weathering and hydrothermal alteration of other clays or feldspar.

The term “talc” as used herein refers to a white mineral form of magnesium silicate (Mg₃Si₄O₁₀(OH)₂) that is often used a filler in paper, paints and rubber.

As used herein, the term “water-soluble glycol” refers to a compound that may dissolve or uniformly disperse in an aqueous medium suitably at ambient temperatures (about 20 degrees Celsius).

As used herein, the term “cellulosic” refers to a polysaccharide composed of glucose units. Sources of cellulosic fibers include, by way of illustration only, woods, such as softwoods and hardwoods; straws and grasses, such as rice, esparto, wheat, rye, and sabai; canes and reeds, such as bagasse; bamboos; woody stalks, such as jute, flax, kenaf, and cannabis; bast, such as linen and ramie; leaves, such as abaca and sisal; and seeds, such as cotton and cotton linters. Softwoods and hardwoods are the more commonly used sources of cellulosic fibers. The fibers may be obtained by any of the commonly used pulping processes, such as mechanical, chemimechanical, semichemical, and chemical processes. Examples of softwoods include, by way of illustration only, longleaf pine, shortleaf pine, loblolly pine, slash pine, Southern pine, black spruce, white spruce, jack pine, balsam fir, Douglas fir, western hemlock, redwood, and red cedar. Examples of hardwoods include, again by way of illustration only, aspen, birch, beech, oak, maple, and gum.

As used herein, the term “hydroneedled” refers to a material that has been subjected to a hydroneedling process. Hydroneedling is a mechanical fiber re-arrangement process that uses fluid jets to cause fibers contained in a web to open up or loosen and rearrange. In particular, during hydroneedling, the fibers tend to swirl causing fibers laying in the X-Y plane of the web to rearrange in the Z direction, increasing the bulk of the web and the strength of the web in the Z direction. In addition, Z direction fibers enhance fluid transport. The force of the fluid jets against the foraminous surface that supports the web also changes the appearance of the web to resemble a woven textile material. Fibers rearrange along defined X-Y planes according to the superimposed topography of the foraminous wire mesh used as a backing during the hydroneedling process.

As used herein, the term “free formaldehyde” or “residual formaldehyde” refers to formaldehyde absorbed by fibers of a base web of a creped material that may be released upon exposure to a pH of about 7 as by wetting the creped material with water.

As used herein, the term “creping” refers to the formation of parallel micro-corrugations in the cross-direction of paper imposed by a doctor blade as the paper is pealed off a steam cylinder. Creping makes the paper softer and more extensible.

### BRIEF DESCRIPTION OF THE DRAWINGS

These and other objects and features of this invention will be better understood from the following detailed description taken in conjunction with the drawings, wherein:

FIG. 1 is a schematic diagram of a process for double creping a base web.

### DESCRIPTION OF PREFERRED EMBODIMENTS

In general, the present invention relates to a creping composition that produces a lower level of free formaldehyde in a creped material. Specifically, the creping composition includes a crosslinkable polymer that releases formaldehyde during crosslinking, a filler material, and a water-soluble glycol compound. It has been discovered that by including a select amount of a glycol compound, in addition to a filler material, with the crosslinkable polymer the level of free formaldehyde in a creped material can be reduced without loss of tensile strength, flexibility, or bulk-producing adhesion on the creping surface. Without wishing to be bound by theory, it is believed that the water-soluble glycol compound, absorbed onto the filler material, acts as a co-solvent for the formaldehyde generated during crosslinking of the polymer. During the curing process the fibrous web is exposed to high temperatures in order to effect crosslinking of the polymer and to dry the fibrous base web. As a result formaldehyde is generated. It is believed that these high temperatures cause the glycol compound to react with the generated formaldehyde to form esters thereby reducing the amount of formaldehyde absorbed by the fibers of the base web. Thus, the resulting creped material has a lower level of free formaldehyde than a comparable creped material that includes the same crosslinkable polymer with or without the filler material.

In one embodiment of the present invention, a creping composition includes a crosslinkable polymer that releases formaldehyde during crosslinking, a filler material, and a glycol compound. Suitably, the creping composition may be an aqueous suspension, emulsion or dispersion that includes about 70 to about 95 weight percent crosslinkable polymer based on total weight of solids in the creping composition, about 5 to about 30 weight percent filler material based on total weight of solids in the creping composition and about 0.5 to about 5.0 weight percent water-soluble glycol compound based on total weight of solids in the creping composition. Desirably, the creping composition has a glass transition temperature of about −30 degrees Celsius to about 10 degrees Celsius.

Crosslinkable polymers suitable for use in the present invention generally have a glass transition temperature of about −5 degrees Celsius to about 5 degrees Celsius. In one embodiment, the crosslinkable polymer may be a latex material such as a crosslinkable ethylene vinyl acetate (EVA) copolymer. Suitably, the EVA copolymer may include n-methylol acrylamide functional groups. In particular, the crosslinkable EVA copolymer may be crosslinked with n-methylol acrylamide functional groups during the creping process using a latent acid catalyst.

One crosslinkable EVA copolymer suitable for use in the present invention is available as a 50 percent solids-in-water emulsion under the trademark AIRFLEX A-105 from Air Products Corporation of Allentown, Pa. Other suitable crosslinkable EVA copolymers having a glass transition temperature of about −5 degrees Celsius to about 5 degrees Celsius are also available as a 50 percent solids-in-water emulsion from National Starch and Chemical Company of Bridgewater, N.J.

Desirably, the creping composition may include a latent acid catalyst that initiates crosslinking of the crosslinkable polymer during the creping process. Suitably, the creping composition includes about 0.3 to about 2 weight percent latent acid catalyst based on the weight of crosslinkable polymer solids. For example, the latent acid catalyst may be present at a level of about 0.5 to about 1 weight percent. Suitable latent acid catalysts include, but are not limited to, ammonium chloride, citric acid, maleic acid and combinations thereof.

The creping composition also includes a filler material in a concentration of about 5 to about 30 weight percent, particularly about 10 to about 25 weight percent, and in one embodiment about 20 weight percent based on total weight of solids in the creping composition. Suitable filler materials include, but are not limited to, clay such as kaolin clay, titanium dioxide, talc, calcium carbonate, and combinations thereof.

Suitably, the filler material includes ultrafine particles. For example, the filler material desirably has a mean particle size less than about 2 microns, suitably less than about 1 micron, and particularly less than about 0.5 microns. It is believed that including an ultrafine particle filler material in the creping composition provides a higher surface area onto which the water-soluble glycol compound may be absorbed. This in turn provides a greater number of sites that may react with the formaldehyde generated during the crosslinking of the crosslinkable polymer and reduce the level of free formaldehyde in the creped material.

In addition to having a small particle size, the filler material desirably has a limited particle size distribution. As used herein, a particle size distribution refers to the fact that all or substantially all of the particles present in the creping composition have a particle size less than a predetermined value. For example, in one embodiment, the filler material may have a particle size distribution of less than about 2 microns, meaning that substantially all of the filler material present in the creping composition has a particle size less than about 2 microns.

Although it is advantageous that most of the filler material included in the creping composition be of a small size, it is believed that it is generally not critical that all of the filler material have an ultrafine size. It is believed that larger particles may be mixed with the smaller particles. For example, in one embodiment, 90 percent of the filler material can have a size less than about 2 microns, particularly less than about 1 micron, and suitably less than about 0.5 microns, which allows for up to 10 percent of the filler material to have a larger size.

In a further example, 99 percent of the filler material may have a particle size of less than about 2 microns, particularly less than about 1 micron, and suitably less than about 0.5 microns.

Particle sizes and particle size distributions as described above can be determined in various manners. For example, a sedigraph can be used to measure the particles. One example of a commercially available sedigraph is the SediGraph 5100 Particle Size Analysis System that is marketed by Micromeritics Corporation of Norcross, Ga.

In one exemplary embodiment, the filler material may include a premium, highly washed, ultrafine particle size clay such as kaolin clay having an average particle size of 0.5 microns and a particle size distribution wherein at least about 99 percent of the particles are less then about 1 micron in size. Suitable clays of this type may be obtained from, for example, IMERYS of Roswell, Ga. or Huber Engineered Materials, a division of the J.M. Huber Corporation, of Atlanta, Ga.

The creping composition also includes a water-soluble glycol compound. It has been found that including a water-soluble glycol compound in the creping composition results in a reduction in the level of free formaldehyde in a creped material. It is believed that the formaldehyde generated during the crosslinking of the crosslinkable polymer reacts with the glycol compound, which is absorbed onto the filler material, to form esters and thereby reduces the level of free formaldehyde in the creped material without affecting the strength and abrasion resistance properties.

The water-soluble glycol compound is included in the creping composition in a concentration of about 0.5 to about 5.0 weight percent based on total weight of solids in the creping composition, desirably about 0.7 to about 2.0 weight percent, and particularly about 1.0 weight percent. Although higher concentrations of the water-soluble glycol compound effectively reduce the level of free formaldehyde remaining in the creped material, such concentration may contribute to loss of adhesion and strength in some creped materials.

Water-soluble glycol compounds suitable for use in the present invention include glycol compounds that are readily soluble or uniformly dispersible in an aqueous medium at room temperature, e.g. about 20 degrees Celsius. Desirably, the water-soluble glycol compounds are temperature stable, meaning that they do not readily evaporate or significantly degrade, at or below process temperatures. For example, the water-soluble glycol compound is suitably temperature stable up to about 290 degrees Celsius, desirably up to about 350 degrees Celsius, and advantageously up to about 375 degrees Celsius or more. Examples of water-soluble glycol compounds useful in the present invention include, but are not limited to, glycerin, polyethylene glycol compounds, polypropylene glycol compounds, and combinations thereof.

In one embodiment, the creping composition may include a water-soluble polyethylene glycol (PEG) compound having a weight average molecular weight of about 200 to about 1000. Examples of such water-soluble PEG compounds include, but are not limited to, a 400 weight average molecular weight polyethylene glycol (PEG 400), a 600 weight average molecular weight polyethylene glycol (PEG 600), an 800 weight average molecular weight polyethylene glycol (PEG 800), and mixtures thereof.

In one exemplary embodiment, the polyethylene glycol compound included in the creping composition may be a 600 weight average molecular weight compound (PEG 600) available under the trademark PLURACOL E 600 from BASF Corporation of Parsipany, N.J. Another suitable polyethylene glycol compound is an 800 weight average molecular weight polyethylene glycol compound (PEG 800) available under the trademark PLURACOL E 800 also from BASF Corporation.

In another aspect, the creping composition of the present invention may be used to prepare a creped material including a fibrous base web. Desirably, the creped material may include about 2 to about 15 weight percent creping composition based on the total weight of the fibrous base web. Suitably, the creped material includes at least about 25 percent, desirably at least about 40 percent, and in one embodiment, at least about 50 percent less free formaldehyde than a comparable creped material including the same crosslinked polymer. Desirably, the creped material includes at least about 10 percent, particularly at least about 15 percent, and in one embodiment at least about 20 percent less free formaldehyde than a comparable creped material including the same crosslinked polymer and filler material. Advantageously, the creped material includes less than about 12 parts per million (ppm) free formaldehyde, desirably less than about 10 ppm free formaldehyde, and in one embodiment less than about 8 ppm free formaldehyde. The amount of free formaldehyde in the creped material may be determined according to the method detailed below.

In general, the creping composition may be used with any suitable nonwoven web or paper-based web. For instance, the base web may be made from pulp fibers, such as softwood fibers, hardwood fibers or mixtures thereof. Alternatively or additionally, the base web may also include synthetic fibers, such as fibers made from various polymeric materials. The synthetic fibers can be staple fibers or can be other various types of fibers or filaments. Furthermore, the base web can be made from a homogeneous mixture of fibers or can be made from a stratified fiber furnish having a plurality of layers that include different types of fibers.

In general, the base web of the present invention should be formed without substantial amounts of inter fiber bond strength. In this regard, in one embodiment, the fiber furnish used to form the base web if containing pulp fibers can be treated with a chemical debonding agent. Suitable, debonding agents that may be used in the present invention include cationic debonding agents such as dialkyl quaternary ammonium salts, monofatty alkyl tertiary amine salts, primary amine salts, imidazoline quaternary salts, silicone quaternary salts, and unsaturated fatty alkyl amine salts. Other suitable debonding agents are disclosed in U.S. Pat. No. 5,529,665 to Kuhn, which is incorporated herein by reference. In particular, Kuhn discloses the use of cationic silicone compositions as debonding agents.

Examples of base materials that may be creped using the creping composition of the present invention include paper and paper products such as tissues, towels, wipes, wipers and the like, and nonwoven materials such as, for example, those disclosed in U.S. Pat. No. 5,284,703 to Everhart et al. and U.S. Pat. No. 6,150,002 to Varona, the disclosures of which are hereby incorporated by reference.

In one embodiment, the base web included in the creped material may be any cellulosic web known to those having ordinary skill in the art. The manner in which the base web is formed may vary depending upon the particular application. For instance, in one embodiment, the base web may be formed in a wet laid process according to conventional papermaking techniques. In a wet laid process, the fiber furnish is combined with water to form an aqueous suspension. The aqueous suspension is spread onto a wire or felt and dried to for the base web. Alternatively, the base web may be formed by an airlaid process. In this embodiment, air is used to transport the fibers to a collecting area to form a web. Airlaid processes are typically capable of processing longer fibers than most wet laid processes, which may provide an advantage in some applications. Optionally, the base web may be hydroneedled to increase the bulk and softness of the base web prior to creping.

Suitably, the base web may have a basis weight of about 25 to about 150 grams per square meter (gsm) or about 15 to about 90 pounds per ream. For example, the base web may have a basis weight of about 45 to about 90 gsm (about 26 to about 53 pounds per ream). As another example, the base web may have a basis weight of about 50 to about 80 gsm (about 29 to about 47 pounds per ream).

A process for producing a creped material includes: providing a fibrous base web; applying a creping composition as disclosed above to at least a first side of the fibrous base web; adhering the at least first side of the fibrous base web to a first creping surface; and creping the fibrous base web from the first creping surface. Optionally, this process may be repeated to form a recreped material wherein at least one side of the base web is subjected to at least two creping cycles.

The creping composition may be applied to the fibrous base web in a preselected pattern. In one embodiment, for example, the creping composition may be applied to the base web in a reticular pattern, such that the pattern is interconnected forming a net-like design on the surface.

In an alternative embodiment, the creping composition may be applied to the base web in a pattern that represents a succession of dots or other geometric shapes. Applying the creping composition in discrete shapes, such as dots, provides strength to the base web without covering a substantial area of the surface of the web.

Desirably, the creping composition is applied to the first side of the fibrous base web in a preselected pattern that covers about 10 to about 60 percent of the surface area of the web. More particularly, in most applications, the creping composition may cover about 20 to about 50 percent of the surface area of each side of the base web. The amount of creping composition applied to each side of the base web may desirably be in the range of about 2 to about 15 weight percent based on the total weight of the base web. For example, the creping composition may be applied to each side of the base web in amount of about 12 percent by weight.

At the above amounts, the creping composition may penetrate the base web from about 10 to about 60 percent of the total thickness of the web. In most applications, the creping material should at least penetrate about 15 percent of the thickness of the web.

The process may also include: applying the creping composition as disclosed above to a second side of the fibrous base web; adhering the second side of the fibrous base web to a second creping surface; and creping the fibrous base web from the second creping surface. Optionally, this process may be repeated to provide a double recreped material wherein each side of the fibrous base web is subjected to at least two creping cycles.

Suitably, the creping composition may be applied to the second side of the base web such that the total amount of creping composition applied to fibrous web is about 2 to about 15 weight percent based on the total weight of the base web. Desirably, the creping composition is applied to the second side of the fibrous base web in a preselected pattern that covers about 20 to about 50 percent of the surface area of the second side.

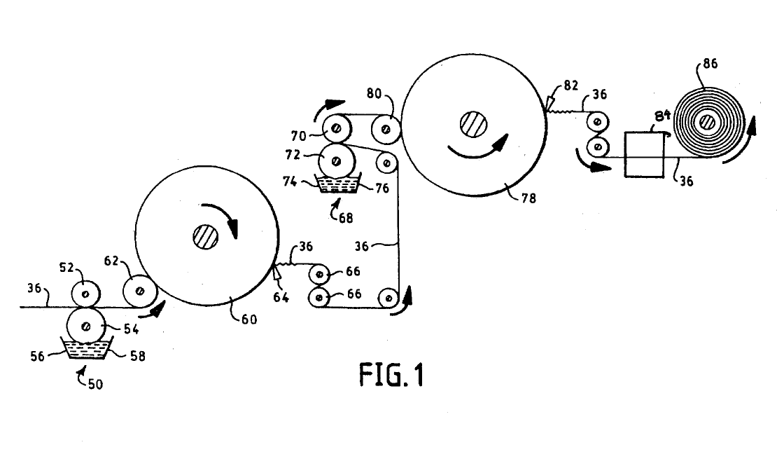

Referring now to FIG. 1, there is shown an exemplary embodiment of a process in which the creping composition is applied to both sides of the fibrous base web 36 and both sides of the base web are creped.

A base web 36 made according to any known process is passed through a first creping composition application station, generally 50. The station 50 includes a nip formed by a smooth rubber press roll 52 and a patterned rotogravure roll 54. The rotogravure roll 54 is in communication with a reservoir 56 containing a first creping composition 58. The rotogravure roll 54 applies the first creping composition to one side of the based web 36 in a first preselected pattern.

The base web 36 is then pressed into contact with a first creping drum 60 by a press roll 62. The base web adheres to the creping drum 60 in those locations where the creping composition has been applied. The creping drum 60 may be heated up to a temperature of about 100 degrees Celsius in order to promote attachment between the base web and the drum surface, to initiate crosslinking of the crosslinkable polymer, and for partially drying the base web.

Once adhered to the creping drum 60, the base web 36 is brought into contact with a creping blade 64. Specifically, the base web 36 is removed from the creping drum 60 by the action of the creping blade 64, performing a first controlled pattern crepe on the base web.

The first-creped base web 36 can be advanced by pull rolls 66 to a second creping composition application station, generally 68. The station 68 includes a transfer roll 70 in contact with a rotogravure roll 72 that is in communication with a reservoir 74 containing a second creping composition 76. Similar to station 50, the second creping composition 76 is applied to the opposite side of the base web 36 in a second preselected pattern that may be the same as or different than the first preselected pattern. Once the second creping composition is applied, the base web 36 is adhered to a second creping drum 78 by a press roll 80. The creping drum 78 may be heated up to a temperature of about 100 degrees Celsius in order to promote attachment between the base web and the drum surface, to initiate crosslinking of the crosslinkable polymer, and for partially drying the base web. The base web 36 is carried on the surface of the creping drum 78 for a distance and is then removed therefrom by the action of a second creping blade 82. The second creping blade 82 performs a second controlled pattern creping operation on the second side of the base web.

Once creped for a second time, the base web 36 is pulled through a curing or drying station 84. Drying station 84 can include any form of heating unit, such as an oven energized by infrared heat, microwave energy, hot air or the like. Drying station 84 may be necessary in some applications to dry the creped base web and/or cure the creping composition. Once drawn thought the drying station 84, the double creped base web 36 may then be wound up on a roll 86. Optionally, the process may be repeated to form a double recreped material.

In a further embodiment, a creping composition as disclosed above may be applied to an airlaid web to provide strength and softness. The creping composition may be applied to the airlaid web by any suitable technique such as, for example, spray coating. The treated airlaid web may then be subjected to heat to induce crosslinking of the crosslinkable polymer, remove the aqueous medium, and bond the fibers.

### EXAMPLES

The following examples were prepared in order to compare creped materials according to the present invention with a comparable creped material that includes the same crosslinkable polymer with and without filler material. Each creped material was tested for free formaldehyde residue using the test method described below.

A cellulosic base web having a basis weight of about 48 pounds per ream (about 81 gsm) was double recreped with the creping compositions as shown in Table 1 according to the process described above. All percentages in Table 1 are based on total weight of solids in the creping composition. The creping compositions were applied at an add-on level of 12 weight percent creping composition based on the weight of the base web.

### Example 1

Samples 1A through 1C were creped with a creping composition including a crosslinkable EVA copolymer available under the trademark AIRFLEX A-105 from Air Products of Allentown, Pa. Samples 1B and 1C were creped with a creping composition including an ultrafine particle kaolin clay obtained from IMERYS of Roswell, Ga. Sample 1C was creped with a creping composition including a 600 weight average molecular weight polyethylene glycol compound (PEG 600) available under the trademark PLURACOL E 600 from BASF Corporation of Parsipany, N.J.

The resulting creped materials were tested according to the method described below to determine the level of residual free formaldehyde in the creped material. The results are included in Table 1 below.

### Example 2

Samples 2A through 2C were creped with a creping composition including a crosslinkable EVA copolymer having a glass transition temperature of about −5 degrees Celsius to about 5 degrees Celsius available from National Starch and Chemical Company of Bridgewater, N.J. Samples 2B and 2C were creped with a creping composition including an ultrafine particle kaolin clay obtained from IMERYS of Roswell, Ga. Sample 2C was creped with a creping composition including a 600 weight average molecular weight polyethylene glycol compound (PEG 600) available under the trademark PLURACOL E 600 from BASF Corporation of Parsipany, N.J.

The resulting creped materials were tested according to the method described below to determine the level of free formaldehyde in the creped material. The results are included in Table 1 below.

TABLE 1

| | Creping Composition | | | |
|---|---|---|---|---|
| | % EVA | % | % | ppm |
| Sample | Copolymer | Clay | PEG 600 | Formaldehyde |
| 1A | 100 | | | 23 |
| 1B | 85 | 15 | | 18.5 |
| 1C | 84 | 15 | 1 | 11.5 |
| 2A | 100 | | | 15 |
| 2B | 80 | 20 | | 12 |
| 2C | 79 | 20 | 1 | 7.8 |

As can be seen from the results in Table 1, the base webs creped with a creping composition including a water-soluble glycol compound, in addition to, a filler material had a lower level of residual formaldehyde than comparable creped materials including the same crosslinkable polymer with and without filler material. Specifically, a 50 percent reduction in residual formaldehyde was seen between Samples 1A and 1C while a 48 percent reduction in residual formaldehyde was seen between Samples 2A and 2C. Additionally, a 19.6 percent reduction in residual formaldehyde was seen between Samples 1A and 1B while a 20 percent reduction in residual formaldehyde was seen between Samples 2A and 2B.

### Test Method for Determining Free Formaldehyde in Creped Materials

The amount of free formaldehyde in a creped material is determined as follows. A 2.5-gram sample of the creped material is cut into small pieces (e.g. about 1 centimeter×1centimeter) and placed in a stoppered flask with 100 milliliters of distilled deionized water. The flask is heated at 40° C. on a shaker for 1 hour. The resulting extract is decanted filtered using a 0.1-micron syringe filter assembly to remove micro particulate matter from the extract. The filtered extract may be further diluted with distilled deionized water if needed. The filtered extract is then analyzed for free formaldehyde according to the liquid chromatography procedure detailed in ASTM D 5910 entitled “Standard Test Method for Determination of Free Formaldehyde in Emulsion Polymers by Liquid Chromatography” using water as the eluent/mobile phase.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. A creping composition comprising:
a crosslinkable polymer capable of forming formaldehyde by a condensation reaction during crosslinking;
a filler material; and
a water-soluble glycol compound.

2. The creping composition of claim 1, wherein the creping composition has a glass transition temperature of about −30 degrees Celsius to about 10 degrees Celsius.

3. The creping composition of claim 1, wherein the creping composition comprises about 70 to about 95 weight percent crosslinkable polymer based on total weight of solids in the creping composition.

4. The creping composition of claim 1, wherein the crosslinkable polymer comprises a crosslinkable ethylene vinyl acetate copolymer.

5. The creping composition of claim 1, wherein the creping composition comprises about 5 to about 30 weight percent filler material based on total weight of solids in the creping composition.

6. The creping composition of claim 1, wherein the filler material comprises a material selected from the group consisting of clay, titanium dioxide, talc, calcium carbonate, and combinations thereof.

7. The creping composition of claim 1, wherein the filler material has a mean particle size of less than about 2 microns.

8. The creping composition of claim 1, wherein the creping composition comprises about 0.5 to about 5.0 weight percent water-soluble glycol based on total weight of solids in the creping composition.

9. The creping composition of claim 1, wherein the water-soluble glycol compound comprises a material selected from the group consisting of glycerin, polyethylene glycol compounds, polypropylene glycol compounds, and combinations thereof.

10. The creping composition of claim 1, comprising:
about 70 to about 95 weight percent of a crosslinkable ethylene vinyl acetate copolymer based on total weight of solids in the creping composition;
about 5 to about 30 weight percent of a filler material having a mean particle size of less than about 2 microns based on total weight of solids in the creping composition; and
about 0.5 to about 5.0 weight percent of a water-soluble polyethylene glycol compound based on total weight of solids in the creping composition.

11. The creping composition of claim 10, wherein the filler material comprises a clay.

12. The creping composition of claim 10, wherein the water-soluble polyethylene glycol has a weight average molecular weight of about 200 to about 1000.

13. A creped material comprising:
a fibrous base web; and
a creping composition including a crosslinked polymer and a filler material,
wherein the filler material includes an ester formed from formaldehyde and a water-soluble glycol compound.

14. The creped material of claim 13, wherein the creped material includes at least about 25 percent less free formaldehyde than a comparable creped material including the same crosslinkable polymer.

15. The creped material of claim 13, wherein the creped material includes at least about 10 percent less free formaldehyde than a comparable creped material including the same crosslinkable polymer and filler material.

16. The creped material of claim 13, wherein the creped material includes less than about 12 parts per million free formaldehyde.

17. The creped material of claim 13, wherein the creping composition comprises about 70 to about 95 weight percent crosslinked polymer based on total weight of solids in the creping composition.

18. The creped material of claim 13, wherein the crosslinked polymer comprises an ethylene vinyl acetate copolymer including n-methylol acrylamide functional groups.

19. The creped material of claim 13, wherein the creping composition comprises about 5 to about 30 weight percent filler material based on total weight of solids in the creping composition.

20. The creped material of claim 13, wherein the filler material comprises a material selected from the groups consisting of clay, titanium dioxide, talc, calcium carbonate, and combinations thereof.

21. The creped material of claim 13, wherein the creping composition comprises about 0.5 to about 5.0 weight percent water-soluble glycol compound based on total weight of solids in the creping composition.

22. The creped material of claim 13, wherein the water-soluble glycol compound comprises a material selected from the group consisting of glycerin, polyethylene glycol compounds, polypropylene glycol compounds, and combinations thereof.

23. A process for producing a creped material comprising the steps of:
providing a fibrous base web having a first side and a second side;
applying a creping composition to at least the first side of the fibrous base web, the creping composition including a crosslinkable polymer which releases formaldehyde during crosslinking, a filler material and a water-soluble glycol compound,
adhering the first side of the fibrous base web to a first creping surface; and
creping the fibrous base web from the first creping surface.

24. The process of claim 23, wherein the creping composition is applied to first side of the fibrous base web in an amount of about 2 to about 15 weight percent based on total weight of the base web.

25. The process of claim 23, wherein the creping composition is applied to the first side of the fibrous base web in a pattern that covers about 20 to about 50 percent of the first side of the fibrous base web.

26. The process of claim 23, wherein the creped material includes at least about 25 percent less free formaldehyde than a comparable creped material including the same crosslinkable polymer.

27. The process of claim 23, wherein the creped material includes less than about 12 parts per million free formaldehyde.

28. The process of claim 23, further comprising the steps of:
applying the creping composition to the second side of the fibrous base web;
adhering the second side of the fibrous base web to a second creping surface; and
creping the second side of the fibrous base web from the second creping surface.

29. The process of claim 28, wherein the creped material includes at least about 25 percent less free formaldehyde than a comparable creped material including the same crosslinkable polymer.

30. The process of claim 28, wherein the creped material includes less than about 12 parts per million free formaldehyde.
